(19) United States
(12) Patent Application Publication
(10) Pub. No.: US 2014/0115358 A1
(43) Pub. Date: Apr. 24, 2014

(54) INTEGRATED CIRCUIT DEVICE AND METHOD FOR CONTROLLING AN OPERATING MODE OF AN ON-DIE MEMORY

(71) Applicant: FREESCALE SEMICONDUCTOR, INC., Austin, TX (US)

(72) Inventors: Michael Priel, Netanya (IL); Dan Kuzmin, Givat Shmuel (IL); Sergey Sofer, Rishon Lezion (IL)

(73) Assignee: Freescale Semiconductor, Inc., Austin, TX (US)

(21) Appl. No.: 14/122,523

(22) PCT Filed: May 27, 2011
(86) PCT No.: PCT/IB2011/052327

§ 371 Date: Nov. 26, 2013

(51) Int. Cl. G06F 3/06

(52) U.S. Cl. CPC G06F 3/0625; G06F 3/0655; G06F 3/0673
USPC 713/320

(57) ABSTRACT

An integrated circuit device comprising at least one instruction processing module, at least one memory comprising at least one memory bank configurable to operate in a first functional mode and at least one further, lower-power mode, and at least one memory mode control module arranged to control switching of the at least one memory bank between the first functional mode and the at least one further, lower-power modes.

### FIELD OF THE INVENTION

The field of this invention relates to an integrated circuit device and a method for controlling an operating mode of at least one memory bank of an on-die memory.

### BACKGROUND OF THE INVENTION

In the field of integrated circuit devices, and in particular in the field of integrated circuit devices for mobile applications, aggressive power management techniques are employed to minimize the power consumption of the integrated circuit (IC) devices. One such power management technique is the use of a ‘drowsy’ mode for on-die memory, whereby at least a part of a memory that is not in use on the current operation cycle may be placed into a drowsy mode that allows bitcell content to be retained whilst reducing leakage current. This reduces power consumption of the IC. Further details about implementing drowsy modes for memory may be found in “Drowsy Caches: Simple Techniques for Reducing Leakage Power”; Krisztián Flautner, Nam Sung Kim, Steve Martin, David Blaauw, Trevor Mudge; Proceedings of 29th Annual International Symposium on Computer Architecture, 2002. Such a drowsy mode is often achieved by reducing the supply voltage to the memory or increasing the virtual ground voltage thereto. When a part of the memory in drowsy mode is subsequently required to be accessed for read or write operations, it is moved out of the drowsy mode into a functional mode.

For integrated circuit devices comprising such on-die memories, operations performed within the integrated circuit device, for example the accessing of on-die memory, are typically synchronous. Accordingly, if an instruction to be executed by, say, a processing core of the integrated circuit device requires access to a part of the on-die memory in drowsy mode, that part of the on-die memory must exit drowsy mode and be capable of being accessed in time for the execution of that instruction.

A problem with this technique of placing parts of on-die memory into such a drowsy mode is that the time required for a part of a memory to exit the drowsy mode in order to be accessed is significant. Accordingly, for high frequency applications, excessive exit time frames may prevent a part of the memory from exiting drowsy mode and being accessed within the same clock cycle as, say, an instruction requiring access thereto, and sometimes within two or more clock cycles thereof. Thus, in order to enable a part of on-die memory in drowsy mode to be brought out of drowsy mode in an acceptable time frame, it is often necessary to initiate the process of exiting drowsy mode in advance.

As is well known in the art, an instruction pipeline is a technique used in a design of computers and other instruction processing digital electronic devices to increase their instruction throughput. An instruction pipeline divides the processing of an instruction into a series of independent stages. Most modern processors are synchronous (i.e. clock driven), and typically consist internally of logic components, e.g. combinational logic components, for performing the various functions required for each stage in the instruction pipeline, and registers, e.g. flip-flops, for storing bit values between each stage. The registers take on (and output) their new values, which are then provided to, and propagated through, the successive logic components, when an active edge of a clock signal arrives. The results of such propagation form the next new values for the successive registers. A conventional instruction pipeline may typically comprise an instruction fetch stage; an instruction decode stage; one or more execution stages, for example a first execution stage and a second execution/memory access stage; and a register write back stage. For such an instruction pipeline, when an instruction requires a memory access (e.g. a read or write) operation to be performed, after the instruction has been fetched and decoded, the memory address to be accessed is typically generated in the first execution stage, and the memory access may then be performed in the second execution/memory access stage.

An indication that an instruction to be executed requires access to a part of on-die memory in drowsy mode may be obtained during the decoding stage of the instruction pipeline. In this manner, it is possible to determine a couple of stages in advance when a part of memory in drowsy mode is required to be accessed, and thereby to pre-emptively initiate the process of bringing that part of on-die memory out of drowsy mode.

For integrated circuit devices comprising on-die memory fabricated using Silicon on Insulator (SOI) technology, the intrinsic capacitance of the on-die memory is relatively small, and as such supply voltage changes, such as those required to bring a part of the memory out of drowsy mode, take a relatively short time. Accordingly, determining during the decoding stage that a part of memory in drowsy mode is to be accessed may provide sufficient advance warning to enable that part of memory to be brought out of drowsy mode in time, where that memory has been fabricated using SOI technology. However, even where the on-die memory has been fabricated using SOI technology, the timings are marginal for high frequency applications. Accordingly, for integrated circuit devices comprising on-die memory that are fabricated using bulk technology, in which the intrinsic capacitance of the memory is larger than for SOI technology and thus the power up times are longer, simply identifying during the decoding stage that a part of memory is required to be brought out of drowsy mode typically does not provide sufficient time for the memory to be brought out of drowsy mode in time to be accessed. This is particularly the case within high frequency applications.

### SUMMARY OF THE INVENTION

The present invention provides an integrated circuit device and a method for controlling an operating mode of at least one memory bank of an on-die memory as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a simplified block diagram of an example of an integrated circuit device.

FIGS. 2 and 3 illustrate examples of the execution of instructions within an instruction pipeline.

FIG. 4 illustrates a simplified flowchart of an example of a method for controlling an operating mode of at least one memory bank of an on-die memory.

### DETAILED DESCRIPTION

Examples of the present invention will now be described with reference to a simplified example of an integrated circuit device comprising an instruction processing module and an on-die memory that is configurable to operate in a first, functional mode and at least one further, lower-power mode, for example a drowsy mode. However, it will be appreciated that the present invention is not limited to the specific instruction processing module and on-die memory arrangement herein described with reference to the accompanying drawings, and may be equally applied to alternative architectures. For example, an integrated circuit device is described comprising a single instruction processing module and a single on-die memory. Alternatively, the present invention may be applied to integrated circuit devices comprising multiple instruction processing modules and/or multiple on-die memories. Furthermore, because the illustrated example embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

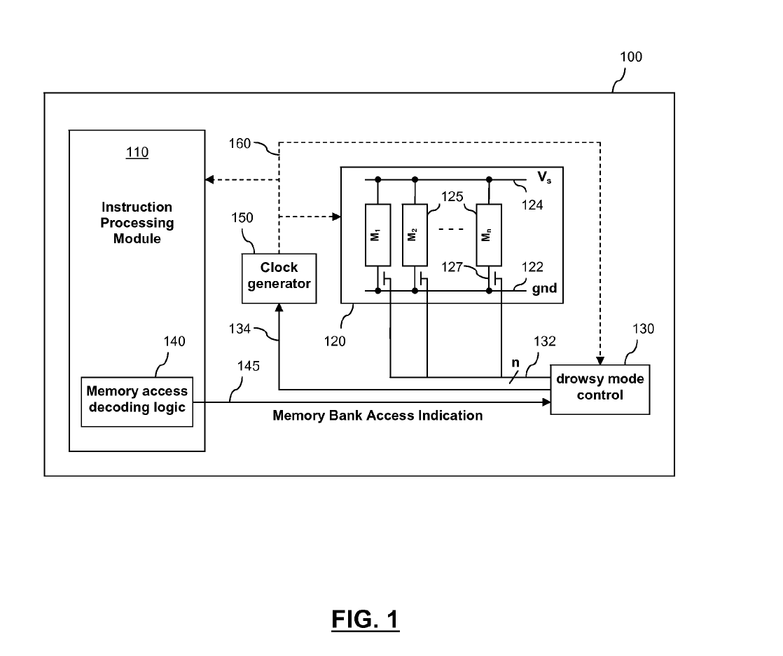

Referring first to FIG. 1, there is illustrated a simplified block diagram of an example of an integrated circuit device 100 comprising an instruction processing module 110 arranged to execute computer program instructions. The integrated circuit device 100 further comprises an on-die memory 120 arranged to store therein data and/or computer program instructions to be accessed by the instruction processing module 110. In the illustrated example, the memory 120 comprises a plurality of memory banks 125, each of which is individually configurable to operate in a first, functional mode in which the content of the respective memory bank is accessible, and at least one further, lower-power, mode. Such a lower-power mode may comprise, for example, a drowsy mode in which bitcell content for the respective memory bank 125 may be retained whilst reducing leakage current, and thus reducing power consumption therefor. Additionally and/or alternatively, such a lower-power mode may comprise a fully powered down mode, in which leakage current may be substantially prevented, but with no content of the respective memory bank 125 retained.

The integrated circuit device 100 further comprises a memory mode control module 130 arranged to control switching of the memory banks 125 between the first, functional mode and the (at least one) further, lower-power mode. For example, the memory mode control module 130 may be arranged to control switching of a memory bank 125 between the first, functional mode and the further, lower-power, mode by configuring a voltage supply and/or voltage reference for the respective memory bank 125. In particular for the illustrated example, the memory mode control module 130 is arranged to control switching of a number of, and in some examples each, memory bank 125 between the first, functional mode and the at least one further, lower-power, mode by configuring, via control signals 132, a virtual ground 127 for the respective memory bank 125. Accordingly, by configuring the virtual ground 127 for a memory bank 125 to be substantially equal to, say, a ground plane 122 of the integrated circuit device 100, a higher potential difference between the virtual ground 127 and a voltage supply 124 of the memory bank 125 may be provided. This enables the first, functional mode therefor whereby the content of the respective memory bank is accessible. Conversely, by configuring a virtual ground 127 for a memory bank 125 to a higher voltage than the ground plane 122 of the integrated circuit device 100, a reduced potential difference between the virtual ground 127 for the memory bank 125 and the voltage supply 124 of the memory bank 125 may be provided, thereby reducing leakage current for the respective memory bank 125.

The integrated circuit device 100 further comprises a clock generator 150 arranged to generate one or more clock signals 160 provided to components of the integrated circuit device 100. In this manner, the operations of the components of the integrated circuit device, and in particular the instruction processing module 100 and memory 120, are synchronised. For the illustrated example, a single, common clock signal 160 has been illustrated as being provided to each of the individually illustrated components of the integrated circuit device 100 for simplicity and ease of understanding. However, it will be appreciated that any configuration of clock signals may be implemented, and in particular it is contemplated that in other examples different clock signals, or variations of a common clock signal, may be provided to different components of the integrated circuit device 100.

The memory mode control module 130 is further arranged to receive forward indications (i.e. in advance) of accesses to be made to the memory banks 125 of the memory 120 by the instruction processing module 110. In this manner, the memory mode control module 130 is able to determine, in advance, when a memory bank 125 is required to be accessed, and therefore required to be switched from the lower-power mode to the functional mode in order to allow the content thereof to be accessed. Furthermore, the memory mode control module 130 is arranged, upon receipt of a forward indication of an access to be made to a memory bank 125 of the memory 120, to cause an increase in a clock cycle duration for at least a clock signal provided to the instruction processing module 100, for example the clock signal 160 of FIG. 1. In addition, the memory mode control module 130 is arranged to cause a change of mode of the at least one memory bank 125 to be accessed to the first, functional mode. In this manner, by dynamically increasing the clock cycle duration for the clock signal that is provided to the instruction processing module 100, the amount of time that is available for bringing the memory bank 125 out of the lower-power mode and into the functional mode may be increased. This facilitates bringing the memory bank 125 out of the lower-power mode and into the functional mode in time in terms of number of clock cycles for the access thereof to be performed. For some cases the time required for bringing the memory bank 125 out of the lower-power mode and into the functional mode may be as big as one clock cycle, if for some reasons getting memory access information in advance is not available.

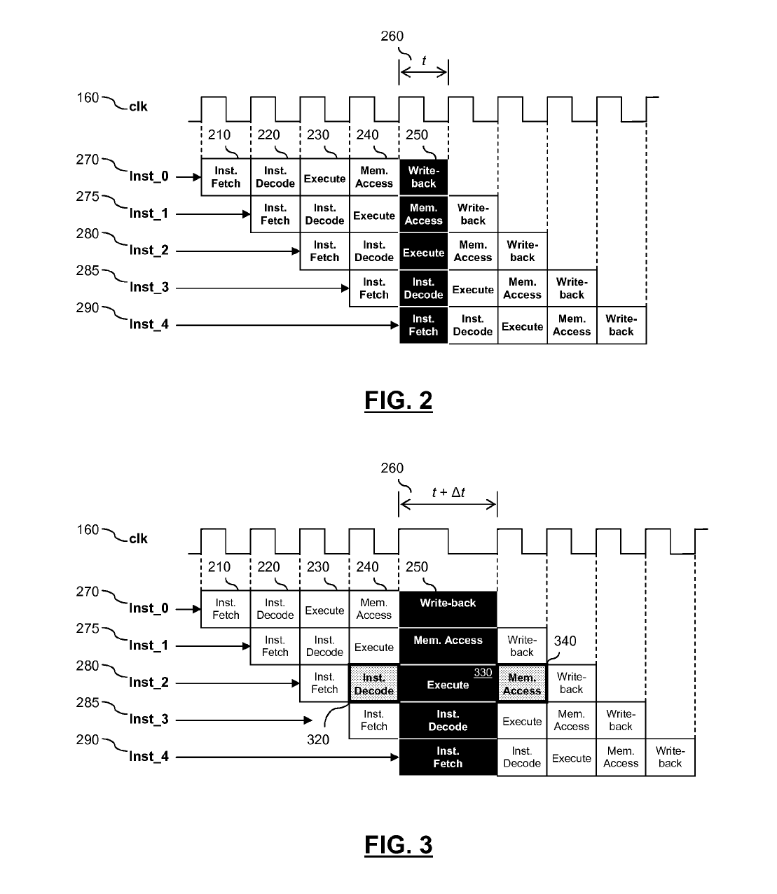

For example, the instruction processing module 110 of FIG. 1 is arranged to implement an instruction pipeline. FIG. 2 illustrates an example of the processing of instructions within an instruction pipeline such as may be implemented within the instruction processing module 110 of FIG. 1. An instruction pipeline divides the processing of an instruction into a series of independent stages. The instruction pipeline of FIG. 2 comprises:
1) an instruction fetch stage 210, in which an instruction to be executed is fetched from, for example, an instruction cache (not shown);
2) an instruction decode stage 220, in which a fetched instruction is decoded to produce the control signals for the data paths in order to execute the instruction;
3) a first execution stage 230, in which required operations for a decoded instruction are executed including, in a case of a memory access instruction, a generation of the memory address to be accessed;
4) a second execution/memory access stage 240, in which (if necessary) further operations for a decoded instruction are executed, or in a case of a memory access instruction the memory access is performed; and
5) a register write back stage 250, in which results (if any) of the execution stages are written into one or more register files.

Thus, and as illustrated in FIG. 2, during a clock cycle 260 of the instruction processing module 110, a first instruction 270 is in the register write back stage 250 of the instruction pipeline; a second consecutive instruction 275 is in the second execution/memory access stage 240 of the instruction pipeline; a third consecutive instruction 280 is in the first execution stage 230 of the instruction pipeline; a fourth consecutive instruction 285 is in the instruction decode stage 220 of the instruction pipeline; and a fifth consecutive instruction 290 is in the instruction fetch stage 210 of the instruction pipeline.

An indication that an instruction to be executed requires access to a part of on-die memory may be obtained during the instruction decode stage 220 of the instruction pipeline. In this manner, it is possible to determine a couple of stages in advance when a part of memory, for example a memory bank 125 of the memory 120 illustrated in FIG. 1, in a lower-power mode is required to be accessed. Thereby, it is possible to pre-emptively initiate the process of bringing that part of on-die memory out of the lower-power mode, and into a functional mode. Accordingly, in the illustrated example of FIG. 1, the integrated circuit device 100 further comprises a decoding module 140 arranged to provide decoding functionality, at least for memory access instructions to be executed within the instruction processing module 110. In the illustrated example, the decoding module 140 is illustrated as comprising an integral part of the instruction processing module 110. However, in some examples, the decoding module 140 may be equally implemented as a component external to the instruction processing module 110. The decoding module 140 is arranged to provide a forward indication 145 of an access that is to be made to a memory bank 125 to the memory mode control unit 130 during an instruction decode stage 220 for a memory access instruction. In this manner, the memory mode control module 130 receives a forward indication of an access to be made to the memory bank 125 of the memory 125 from the decoding module 140 in advance of the clock cycle within which the memory access is required to be made. In particular for the illustrated example, the memory mode control module 130 receives the forward indication two clock cycles in advance.

In some examples, the memory mode control module 130 may be arranged, upon receipt of a forward indication of an access to be made to a memory bank 125 of the memory 120, to cause an increase in a clock cycle duration for at least the clock signal 160 provided to the instruction processing module 100. In this manner, the duration of the subsequent clock cycle may be extended from an initial duration of t to an extended duration of t+Δt. As a result, the subsequent stages of the instruction pipeline for the memory access instruction are effectively slowed down, thereby providing a longer period of time within which to bring the memory bank 125 to be accessed out of the lower-power mode and into the functional mode.

FIG. 3 illustrates an example of such an increase in the clock cycle duration during the processing of instructions within the instruction pipeline. In the illustrated example, instruction Inst_{—}2 280 comprises a memory access instruction, for which a memory bank 125 of the memory 120 of FIG. 1 is required to be accessed. During the decode stage 320 of the memory access instruction 280, the decoding module 140 provides a forward indication 145 of the memory access to the memory mode control module 130, thereby indicating that a memory bank 125 will be required to be accessed, and identifying the specific memory bank 125 to be accessed. In response to the received forward indication 145 from the decoding module 140, the memory mode module 130 causes the clock generator 155, for example via control signal 134 of FIG. 1, to increase the clock cycle duration for the clock signal 160. Such an increase in the clock cycle duration may be achieved by, for example, inverting the clock signal 160, skipping a next edge of the clock, etc. In this manner, and as illustrated in FIG. 3, the duration of the subsequent clock cycle, and thus the subsequent stage within the instruction pipeline for the memory access instruction 280, may be extended from an initial duration of t to an extended duration of t+Δt. Thus, for the memory access instruction, Inst_{—}2, 280, the duration of the first execution stage 330 therefor is extended, delaying the start of the memory access stage 340 therefor and, thus, delaying the time by which the memory bank 125 being accessed is required to have completed its change from being in the lower-power mode to the functional mode.

Thus, by enabling the time by which a memory bank being accessed is required to have completed its change from the lower-power mode to the functional mode to be delayed in this manner, it is possible to overcome the aforementioned problem of the relatively long time period required for the memory bank to exit the lower-power mode. In particular, by making Δt sufficiently large, it is possible to use ‘drowsy mode’ power management techniques for on-die memories that are fabricated using bulk technology.

In order to minimize any impact on system performance, the memory mode control module 130 may be further arranged to cause a reduction of the clock cycle duration for the clock signal 160 to its previous duration subsequent to the at least one memory bank 125 entering the first, functional mode.

In practice, drowsy mode power management techniques are typically implemented where an ‘in use’ memory bank, e.g. a memory bank being accessed, of an on-die memory is configured to operate in a functional mode (e.g. fully powered up), whilst the remaining ‘dormant’ memory banks of the on-die memory are configured to operate in a lower-power (drowsy) mode. When a dormant memory bank is required to be accessed, that dormant memory bank is ‘woken up’, for example it is caused to change from the lower-power mode to a functional mode, whilst the previously ‘in use’ memory bank is put into a drowsy state, i.e. caused to change from the functional mode to the lower-power mode.

Thus, for such drowsy mode power management techniques, the memory mode control module 130 of FIG. 1 may be arranged to determine whether a memory access relates to an ‘in use’ memory bank or a ‘dormant’ memory bank, upon receipt of a forward indication of a memory access. If the memory mode control module 130 determines that the memory access relates to an ‘in use’ memory bank, the memory mode control module 130 need do nothing, since the memory bank to be accessed is already in the functional mode. However, if the memory mode control module 130 determines that the memory access relates to a ‘dormant’ memory bank, the memory mode control module 130 may then be arranged to cause an increase in the clock cycle duration for the clock signal 160 provided to the instruction processing module 110, and to cause a change of mode of the dormant memory bank to the functional mode. The memory mode control module 130 may also be arranged to cause the previously ‘in use’ memory bank to change to the lower-power mode. Thus, in this manner, the memory mode control module 130 may be arranged, upon receipt of a forward indication of an access to be made to a memory bank 125 of the on-die memory, to determine whether a memory bank switch is required, e.g. whether the memory access requires access to a currently dormant memory bank 125. If the memory mode control module 130 determines that a memory bank switch is required, the memory mode control module 130 then causes an increase in the clock cycle duration for the clock signal 160 provided to the instruction processing module 110, and causes a change of mode of the dormant memory bank 125 to be accessed to the functional mode.

Alternatively, for the illustrated example, the decoding module 140 may be arranged, upon decoding a memory access instruction, to determine whether or not a memory bank switch is required, for example whether or not the memory access instruction requires access to a dormant memory bank. If the decoding module 140 determines that a memory bank switch is required, the decoding module 140 may then provide a forward indication 145, of an access to be made to a memory bank 125, to the memory mode control module 130. Conversely, if a memory bank switch is not required, i.e. the memory bank 125 to be accessed is already operating in the functional mode, the decoding module 140 need not provide a forward indication 145 to the memory mode control module 130. Thus, the requirement for determining whether or not a memory bank switch is required, and thus whether or not a memory bank 125 is required to be brought out of a drowsy mode, may be provided within either of the memory mode control module 130 or, for the illustrated example, the decoding module 140.

In the illustrated examples hereinbefore described, a forward indication of an access to be made to a memory bank 125 is obtained during an instruction decoding stage. As such, a determination of whether or not a memory bank switch is required, and thus whether or not a memory bank 125 is required to be brought out of a drowsy mode, may be made prior to the start of the clock cycle in which the memory access is to occur. Accordingly, a decision to increase a clock cycle duration may be made prior to the start of the specific clock cycle for which the duration is to be increased.

However, in alternative examples of a memory access scenario, a forward indication of an access to be made to a memory bank 125 may be obtained, say, at the beginning of the clock cycle in which the memory access is to occur. Such a scenario may place a requirement for bringing the memory bank 125 into functional mode in one cycle. Accordingly, a decision to increase a clock cycle duration, and the implementation of such an increase of the clock cycle duration, may be made at the start of the specific clock cycle for which the duration is to be increased, whilst still enabling sufficient time for the next ‘raw’ clock signal gating for which the memory access is required to be activated. The rate of switching memory banks is typically not high for high activity applications. Thus, any impact on the average operating frequency, due to temporarily increasing the clock cycle duration is not high. In addition, any impact of implementing the present invention may be minimized by, for example, disabling the increase in clock cycle duration in response to a forward indication of a memory access where the operating frequency of the instruction processing module is sufficiently low. Such a scenario may, for example, occur when the clock frequency is reduced for power management purposes and where a memory bank is brought out of a drowsy state in time without further changes to the clock signal being required. In addition, in some examples, the increase in the clock cycle duration (Δt) may be configurable and/or otherwise dynamically variable in response to, say, the operating frequency of the instruction processing module. In this manner, the increase in the clock cycle duration (at) may be substantially optimized to provide sufficient time to bring a memory bank 125 out of a drowsy state, whilst minimizing any impact on performance of the instruction processing module 110.

Those skilled in art may note that the time required to bring the memory module from a low power mode to the functional mode depends very much upon manufacturing process distribution corner (fast/normal/slow), operating voltage and temperature. Therefore, configuration of the increase in the clock cycle duration (Δt) may be taken based on an on-die monitoring unit result, if such unit exists in the integrated circuit device, (The on-die monitoring unit is a functional unit, which presents on typical modern VLSI device and serves to monitor manufacturing process distribution corner, local power supply voltage and temperature—all parameters which influence VLSI device performance, leakage current and other.)

The memory mode control module 130 has hereinbefore been described as being arranged to cause an increase in a clock cycle duration for a clock signal 160 provided to at least the instruction processing module 110, upon receipt of a forward indication of a memory access. Many of the components of an integrated circuit device comprising an instruction processing module may form part of a synchronous system. As such, altering the clock signal 160 provided to the instruction processing module 110 of FIG. 1 may have implications for the synchronisation of those components with the instruction processing module 110. As such, in some examples, the memory mode control module 130 may be arranged to cause an increase in a clock cycle duration for one or more clock signals (such as may be illustrated generally at 160) distributed throughout components of the integrated circuit device 100 that are synchronised with the instruction processing module 110.

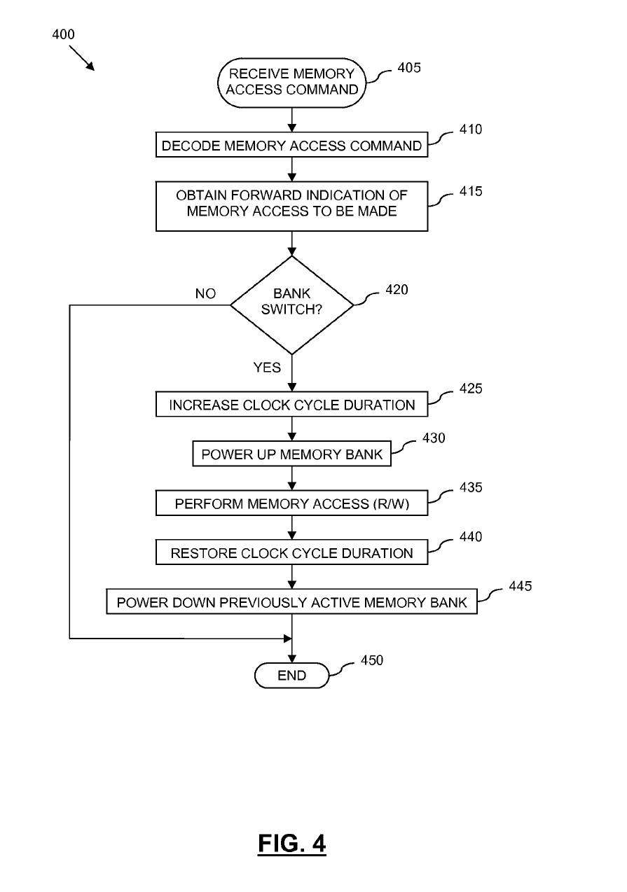

Referring now to FIG. 4, there is illustrated a simplified flowchart 400 of an example of a method for controlling an operating mode of at least one memory bank of an on-die memory, such as may be implemented within the integrated circuit device 100 FIG. 1. The method starts at 405 with a receipt of a memory access command, for example as part of an instruction fetch stage, such as instruction fetch stage 210 of FIG. 2, within an instruction pipeline of the instruction processing module 110. The memory access command is then decoded at 410, for example by the decoding module 140 of FIG. 1 as part of the decoding stage 220 within the instruction pipeline of instruction processing module 110. Next, at 415, a forward indication of the memory access to be made is obtained, for example from the decoding of the memory access command within the decoding stage 220 of FIG. 2 within the instruction pipeline of the instruction processing module 110. In the illustrated example, it is then determined whether or not the memory access requires a memory bank switch. If no memory bank switch is required, for examples where the memory bank to be accessed is already in a functional mode, the method ends at 450. Conversely, if it is determined that a memory bank switch is required, for example where the memory bank to be accessed is currently dormant and in a lower-power, drowsy mode, the method moves on to 425, where a clock cycle duration for at least a clock signal provided to the instruction processing module is increased. The one memory bank to be accessed is caused to switch from the lower-power mode to the functional mode, which in the illustrated example comprises powering up the memory bank, for example by re-configuring a virtual ground or voltage supply level for the memory bank. The memory bank may then be accessed, for example the required read/write access may be performed, as illustrated at 435. The clock cycle duration for at least a clock signal provided to the instruction processing module may then be reduced back to its previous duration, at 440. A previously active memory bank may then be caused to change to a lower-power, drowsy mode, for example by being (partially) powered down, as illustrated at 445. The method then ends at 450.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the memory mode control module 130 of FIG. 1 has been illustrated as comprising a distinct functional block within the integrated circuit device 100 separate from the instruction processing module 110, and the memory 120. However, the memory mode control module 130 may equally be implemented as an integral part of the instruction processing module 110 or the memory 120, or with the functionality of the memory mode control module 130 being distributed between elements of the instruction processing module 110 and the memory 120.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising:
at least one instruction processing module;
at least one memory comprising at least one memory bank configurable to operate in a first functional mode and at least one further lower-power mode; and
at least one memory mode control module arranged to control switching of the at least one memory bank between the first functional mode and the at least one further lower-power mode, wherein
the memory mode control module is further arranged to receive at least one forward indication of at least one access to be made to the at least one memory bank of the at least one memory, and upon receipt of a forward indication of an access to be made to the at least one memory bank, to:
cause an increase in a clock cycle duration for at least a clock signal provided to the at least one instruction processing module, and
cause a change of mode of the at least one memory bank of the memory from the at least one further lower-power mode to the first functional mode.

2. The integrated circuit device of claim 1 further comprising at least one decoding module arranged to decode at least one memory access instruction to be executed within the at least one instruction processing module.

3. The integrated circuit device of claim 2 wherein the at least one memory mode control module is arranged to receive the at least one forward indications of the at least one access to be made to the at least one memory bank of the memory from the at least one decoding module.

4. The integrated circuit device of claim 3 wherein the at least one decoding module is arranged to provide the at least one forward indication to the at least one memory bank of the at least one memory upon decoding a memory access instruction to be executed within the at least one instruction processing module.

5. The integrated circuit device of claim 4 wherein the at least one decoding module is arranged to, upon decoding the at least one memory access instruction:
determine whether a switch of the at least one memory bank is required; and if the decoding module determines that a memory bank switch is required provide the forward indication of an access to be made to the at least one memory bank of the memory.

6. The integrated circuit device of claim 1 wherein the at least one memory mode control module is arranged to, upon receipt of a forward indication of an access to be made to the at least one memory bank:
determine whether a memory bank switch is required for the memory bank access to which the forward indication relates; and if the at least one memory mode control module determines that a memory bank switch is required:
cause an increase in a clock cycle duration for at least the clock signal provided to the at least one instruction processing module; and
cause a change of mode of the at least one memory bank of the at least one memory to the first functional mode.

7. The integrated circuit device of claim 1 wherein the at least one memory mode control module is arranged to control switching of the at least one memory bank between the first functional mode and the at least one further lower-power mode by configuring at least one voltage supply or reference voltage for the at least one memory bank.

8. The integrated circuit device of claim 4 wherein the at least one memory mode control module is arranged to control switching of the at least one memory bank between the first and at least one further modes by configuring a virtual ground for the at least one memory bank.

9. The integrated circuit device of claim 1 wherein the at least one memory mode control module is arranged to cause an increase in a clock cycle duration for at least one clock signal distributed throughout a plurality of components of the integrated circuit device that are synchronised with at least one from a group consisting of the instruction processing module, the memory block.

10. The integrated circuit device of claim 1 wherein the at least one memory mode control module is further arranged to cause a reduction of the clock cycle duration for at least the clock signal to its previous clock cycle duration subsequent to the at least one memory bank entering the first functional mode.

11. The integrated circuit device of claim 1 wherein the at least one further lower-power mode of the at least one memory bank of the at least one memory comprises a drowsy mode that allows bitcell content to be retained within the at least one memory bank.

12. The integrated circuit device of claim 11 wherein the drowsy mode allows bitcell content to be retained within the at least one memory bank whilst reducing leakage current therefor.

13. A method for controlling an operating mode of at least one memory bank of an on-die memory, the at least one memory bank being configurable to operate in a first functional mode and at least one further lower-power mode; the method comprising:
receiving at least one forward indication of at least one access to be made to the at least one memory bank of the on-die memory by at least one instruction processing module;
increasing a clock cycle duration for at least a clock signal provided to the at least one instruction processing module; and
causing the at least one memory bank to switch from the at least one lower-power mode to the first functional mode.

14. The method of claim 13 further comprising:
decoding at least one memory access instruction to be executed within the at least one instruction processing module.

15. The method of claim 14 further comprising:
decoding a memory access instruction to be executed within the at least one instruction processing module; and
providing the at least one forward indication of the at least one access to be made to the at least one memory bank of the on-die memory, upon said decoding the memory access instruction.

16. The method of claim 15 further comprising, upon said decoding the memory access instruction:
determining whether a switch of the at least one memory bank of the on-die memory is required; and
if a switch of the at least one memory bank of the on-die memory is required, then providing the forward indication of an access to be made to the at least one memory bank of the memory.
